(19) United States
(12) Patent Application Publication
(10) Pub. No.: US 2004/0021065 A1
(43) Pub. Date: Feb. 5, 2004

(54) Test body and test body systems for nuclear medicine devices, production and use thereof

(76) Inventor: Simone Weber, Duren (DE)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/333,003

(22) PCT Filed: Jul. 14, 2001
(86) PCT No.: PCT/DE01/02721

(30) Foreign Application Priority Data
Jul. 22, 2000 (DE) 100 35 751.2

(51) Int. Cl. G12B 13/00

(52) U.S. Cl. 250/252.1

(57) ABSTRACT

The invention relates to a phantom for testing nuclear medicine instruments, such as for positron emission tomographs (PET), single-photon emission computed tomographs (SPECT) or even for autoradiography. The phantom contains a solid body that spontaneously emits gamma radiation or positrons. The disadvantages of a phantom filled with a radioactive liquid can be routinely overcome therewith. The inventive phantom can be produced with structuring smaller than 1 mm, and in particular even smaller than 0.1 mm. The inventive phantom can be used for the first time both for positron emission tomography (PET) and for autoradiography, since the phantom can emit both gamma radiation and positron radiation.

The invention relates to a phantom and to a phantom system for testing nuclear medicine instruments, especially for positron emission tomography (PET) and autoradiography. The invention further relates to the production and use of such phantoms and phantom systems.

In nuclear medicine diagnoses, the metabolism of tissue is examined by injecting a radioactively labeled substance into a patient. This substance is absorbed, in a manner that depends on the metabolism, by the tissue, from which gamma radiation is then emitted. Position-sensitive detection of this gamma radiation, for example by means of a gamma camera, positron emission tomography (PET) or single-photon emission computed tomography (SPECT), yields information about the metabolism. To evaluate these diagnostic instruments, it is necessary to image unambiguously known activity distributions, in order to be able to obtain information on the quality or usability of these instruments. In this connection, it is also desirable to simulate (morphological) structures that approximate reality.

Phantoms used in standard practice are made of plexiglass or glass in an arrangement containing cavities (such as spherical or cylindrical) filled with a radioactive fluid. Phantoms of this type are also suggested by the NEMA Standard (National Electrical Manufacturers Association) for characterization of positron emission tomographs (J. S. Karp et al., “Performance standards in positron emission tomography,” J. Nucl. Med. 12 (32) pp. 2342-2350, 1991). The spatial resolution of the instruments, however, has been greatly improved by advances in the instrumentation area. The phantoms must be made compatible with this improved spatial resolution, by formation of smaller structures. A disadvantage of fillable phantoms is that, because of the capillary effect, very small structures cannot be filled or can be filled only with great difficulty. Particularly for simulation of a morphological structure (such as rat brain) with a 3-dimensional phantom, it must also be ensured that internal structures are free of air bubbles when they are filled. If a phantom is constructed from individual layers containing countersunk patterns in the form of the morphological structures, the problem of radioactive contamination between the layers occurs because of the introduction of the radioactive fluid and thus the induction of undesired radioactive background radiation. A further disadvantage can be that the radioactivity is not homogeneously distributed in a liquid or even undergoes phase separation, thus leading to artifacts in the measurement.

From U.S. Pat. No. 5,502,303 there is known a phantom for calibration of gamma radiation instruments. A slow positron source, comprising a cylinder filled with positron-emitting, liquid radioisotopes, sends a positron beam to a screen. When the positrons impinge on the screen, they produce gamma rays, which can be read by PET or SPECT cameras. The positron beam can be influenced by the fact that the image of the desired phantom is produced on the screen.

In U.S. Pat. No. 5,165,050 there is described a spherical phantom (phantom system) by means of which it is possible to test operating characteristics of instruments capable of displaying images of human internal tissues in one plane. Individual test objects, such as plates for determination of the resolution, low-contrast plates or even sensor arrays, are advantageously disposed inside the phantom.

Furthermore, there is disclosed in U.S. Pat. No. 4,499,375 a phantom, comprising a hollow cylinder, for testing nuclear medicine instruments. In its interior there is described an arrangement of identically shaped rods, which are disposed in a parallel and uniform manner, such as hexagonally. A liquid surrounds the rods. The material of either the liquid or the rods is radioactive, and so a radioactive contrast exists between the rods and the surroundings.

The object of the invention is to provide a phantom or a phantom system for testing nuclear medicine instruments as well as a method for production of the same, wherein there are used radiation-emitting 2-dimensional and/or 3-dimensional structures in the range smaller than 1 mm.

The object is achieved by a phantom according to claim 1, a phantom system according to claim 7 and production methods according to claims 11, 15 or 16. Advantageous embodiments are specified in the dependent claims based thereon.

The inventive phantom according to claim 1 is provided with a radiation-emitting solid body containing, in parts at least, defined 3-dimensional structuring in the range smaller than 1 mm.

The radiation can be, for example, positron radiation or gamma radiation. Thus the inventive phantom is suitable for use by nuclear medicine instruments, such as a gamma camera, a positron emission tomograph (PET), a single-photon emission computed tomograph (SPECT) or even an autoradiograph.

The radiation-emitting solid body is a material, especially a metal, which itself is made radioactive by appropriate irradiation, for example by neutrons or in the cyclotron.

Furthermore, the inventive phantom contains, at least in parts, a 2-dimensional or 3-dimensional structure in the range smaller than 1 mm. To be understood by this is that the phantom contains a defined structure on its surface and/or in its interior, the structures being smaller than 1 mm. Examples of such structures are:

net-like fabric, with a mesh opening smaller than 1 mm or a wire thickness smaller than 1 mm,

parallel channels on the surface, with a spacing or with ridges smaller than 1 mm,

grid of points with a spacing of smaller than 1 mm,

defined cavities, whose extents are smaller than 1 mm in one dimension, in the interior of the solid body,

the simulation of a morphological structure with uniform regions that are smaller than 1 mm in one dimension.

By structuring within the meaning of the invention there is to be understood 2-dimensional or 3-dimensional structuring in the range smaller than 1 mm, especially smaller than 0.5 mm. Advantageously, structures in the range of about 0.1 mm and smaller are also achieved. Thus it is possible, with this inventive phantom, to simulate morphological structures such as those found in rat brain in accurate detail. Depending on measurement method and instrument, the phantom can be advantageously formed as a 3-dimensional structure, for PET measurements, for example, or else as a 2-dimensional structure, such as an ultra-thin layer for application on a film for measurements with an autoradiograph.

By means of the inventive phantom it is possible advantageously to evaluate diagnostic instruments. The activity distribution of the phantom is measured and compared with the actual extents of the structured phantom. In this way information on the position-sensitive detection of individual measuring instruments can be obtained.

Furthermore, ultra-small structures can be formed in simple manner from the inventive solid body. In the case of metals as the solid body, the structuring can be appropriately applied by techniques analogous to those of electronic circuitry or computer chips, wherein the desired structures can be produced, for example, by masking and etching.

In advantageous embodiments of the phantom according to claim 5 and 6, phantoms for special uses can be created via the choice of material of the solid body to be used and the type of irradiation.

In a further advantageous embodiment, a phantom system is composed on individual inventive phantoms. Suitable individual phantoms for this purpose have the form of thin slices or layers and, when appropriately combined, yield a 3-dimensional phantom system. Such a phantom system advantageously simulates a morphological structure, such as a brain or other organ.

In the inventive method for production of a phantom system, two alternatives are advantageously available. In one case, structuring of the solid body and assembly of individual phantoms as a phantom system is performed first, after which the system is made radioactive by irradiation as one unit. In the other case, however, individual phantoms can be structured and irradiated in the first step. Only thereafter are the phantoms combined as a 3-dimensional phantom system.

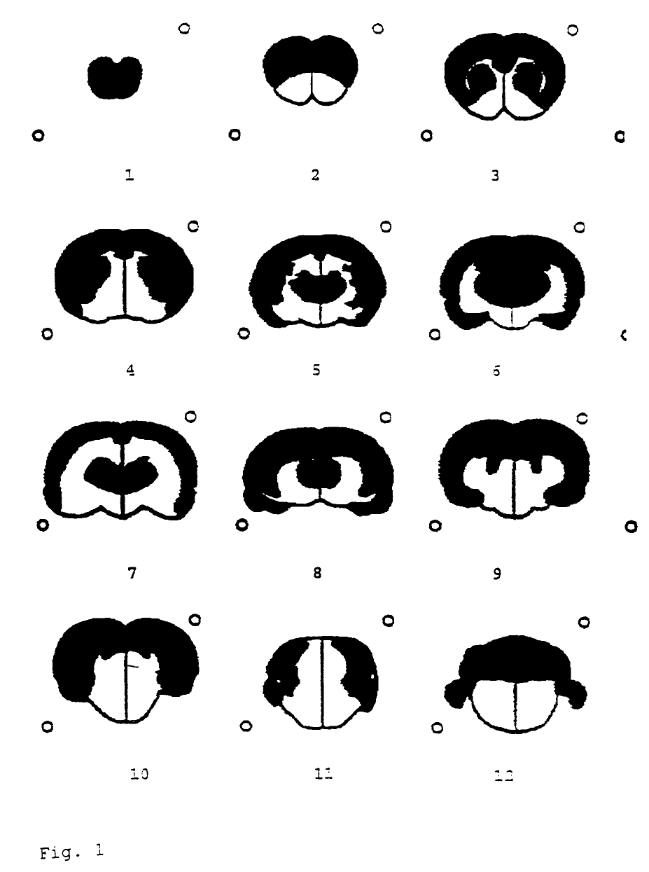

The invention will be explained in more detail hereinafter by means of a practical example and of a figure, wherein FIG. 1 shows examples of the inventive phantoms in the form of individual layers (sections), which reproduce the morphological structures of a rat brain (magnified by a factor of about 2¼). The subject matter of the present invention is a method for production of phantoms for testing nuclear medicine diagnostic instruments based on the measurement of radioactivity distributions (such as PET, SPECT, gamma camera). Since it is possible to activate solid bodies such as copper, silver and gold by, for example, irradiation with neutrons or by cyclotrons, there can be produced a phantom by first making the structures of interest from a suitable material and then making the material itself radioactive, for example by irradiation. The type of phantom (for example, 3-dimensional body or individual layers, use of films on support material, etc.) and the material are dictated by the particular problem to be solved.

The production of a layered rat-brain phantom of copper for positron emission tomography will be described as the practical example. By analogy with the production of printed circuits in electronics, structures of no interest are etched away and the remaining copper can be transformed by neutron irradiation to Cu-64, which is a positron emitter.

If such a phantom is to be used for a different method, a different suitable material will be chosen accordingly, such as a gamma-radiation emitter for use in SPECT.

For positron emission tomography in particular, this phantom for the first time makes it possible, by using the same phantom, to obtain a direct comparison of the method with autoradiography, which to some extent can be replaced by high-resolution positron-emission tomography. Heretofore the use of identical phantoms has not been possible, since positrons are detected directly by means of autoradiography, whereas in PET it is the gamma quanta formed by annihilation of the positrons that are detected. The positrons are absorbed in the envelope needed for the liquid radioactive substance, and so it was not possible to reach the measuring range, thus making a measurement impossible. Since an envelope is not necessary for a solid phantom, the interfering layer is not present, meaning that measurement by means of autoradiography is possible, as is therefore calibration of the positron emission tomograph.

1. A phantom for testing nuclear medicine instruments,
characterized by
a radiation-emitting solid body which, at least in parts, has 2-dimensional or 3-dimensional defined structuring in the range smaller than 1 mm.

2. A phantom according to claim 1, in which the solid body contains copper, zinc, silver or gold.

3. A phantom according to claim 1 or 2, which simulates, at least in part, a morphological structure.

4. A phantom according to one of the preceding claims, in the form of a layer with a thickness of less than 1 mm.

5. A phantom according to one of the preceding claims, which emits positron radiation.

6. A phantom according to one of the preceding claims, which emits gamma radiation.

7. A phantom system, comprising at least two phantoms according to one of the preceding claims.

8. A phantom system, comprising at least two phantoms according to one of the preceding claims,
wherein a morphological structure is simulated.

9. The use of a phantom according to claim 5 for autoradiography.

10. The use of a phantom according to claim 6 for single-photon tomography.

11. A method for production of a phantom according to one of claims 1 to 6, with the following steps:
a solid body is machined in such a way that it contains, at least in parts, 2-dimensional or 3-dimensional structuring in the range smaller than 1 mm;
the structured solid body is irradiated to make it radioactive.

12. A method according to claim 11, in which the structuring is produced by etching the solid body.

13. A method according to claim 11, in which the structuring is produced by deposition on a solid body.

14. A method according to one of claims 11 to 13, in which there is used a layer-like solid body with a thickness of less than 1 mm.

15. A method for production of a phantom system, with the following steps:
at least two layer-like solid bodies are machined in such a way that they contain, at least in parts, 2-dimensional or 3-dimensional defined structuring in the range <1 mm;
the layer-like, structured solid bodies are arranged as a layered system in such a way that this simulates at least partly a morphological structure;
the layered system is irradiated to make it radioactive.

16. A method for production of a phantom system, with the following steps:
at least two layer-like solid bodies are machined in such a way that they contain, at least in parts, 2-dimensional or 3-dimensional defined structuring in the range <1 mm;
the layer-like, structured solid bodies are arranged as a layered system in such a way that this simulates at least partly a morphological structure;
the layered system is irradiated to make it radioactive.

17. A method according to claim 15 or 16, in which the structuring of the solid body is produced by etching.

18. A method according to one of claims 11 to 17, in which copper is used as the solid body and this structured solid body is transformed by neutron irradiation to a Cu-64 emitter.
